(19) United States
(12) Patent Application Publication
(10) Pub. No.: US 2018/0302490 A1
(43) Pub. Date: Oct. 18, 2018

(54) DYNAMIC CONTENT DELIVERY NETWORK (CDN) CACHE SELECTION WITHOUT REQUEST ROUTING ENGINEERING

(71) Applicants: Andre Surcouf, Saint Leu La Foret (FR); Enzo Fenoglio, Issy-les-Moulineaux (FR); Hugo Latapie, Long Beach, CA (US); Joseph Friel, Ardmore, PA (US); Thierry Gruszka, Le Raincy (FR)

(72) Inventors: Andre Surcouf, Saint Leu La Foret (FR); Enzo Fenoglio, Issy-les-Moulineaux (FR); Hugo Latapie, Long Beach, CA (US); Joseph Friel, Ardmore, PA (US); Thierry Gruszka, Le Raincy (FR)

(73) Assignee: Cisco Technology, Inc., San Jose, CA (US)

(21) Appl. No.: 15/486,524

(22) Filed: Apr. 13, 2017

(51) Int. Cl. H04L 29/08; H04L 12/721; G06N 99/00

(52) U.S. Cl. CPC H04L 67/2842; H04L 67/1097; G06N 99/005; H04L 45/12

(57) ABSTRACT

According to one aspect, a method includes obtaining a request for content through a physical network layer at a first node, the first node being one of a plurality of nodes in a content network layer, each node of the plurality of nodes including the content, wherein the request includes a first packet. The method also includes identifying a second node of the plurality of nodes from which to obtain the content, and inserting a segment routing (SR) list into the first packet, the SR list specifying an address of the second node as a next destination of the first packet. Finally, the method includes providing the packet including the SR list from the first node to the second node, wherein the second node is arranged to change the next destination of the packet to an address of the content included on the second node.

### TECHNICAL FIELD

The disclosure relates generally to delivering content within networks. More particularly, the disclosure relates to delivering content from a most appropriate cache without utilizing a request routing engineering process.

### BACKGROUND

Individual content is often physically housed in different physical caches within a network. Typically, in a classical content delivery network (CDN), a cache from which to obtain content may be selected through the use of a request routing engineering process, e.g., a hypertext transfer protocol (HTTP) request routing engineering process. Logic associated with a request routing engineering process is generally configured to select the most appropriate cache from which to retrieve particular content. Such logic is often complex.

### BRIEF DESCRIPTION OF THE DRAWINGS

The disclosure will be readily understood by the following detailed description in conjunction with the accompanying drawings in which:

FIG. 1A is a diagrammatic representation of a network in which caches advertise their contents in accordance with an embodiment.

FIG. 1B is a diagrammatic representation of a network, e.g., network 100 of FIG. 1A, in which contents are provided in response to a request from a device by a most appropriate cache in accordance with an embodiment.

FIG. 2 is a process flow diagram which illustrates a method of obtaining contents from an appropriate cache in accordance with an embodiment.

FIG. 3 is a diagrammatic representation of a vector packet processing (VPP) node in accordance with an embodiment.

FIG. 4 is a diagrammatic representation of an overall network with a physical plane and a “content” plane in accordance with an embodiment.

FIG. 5 is a process flow diagram which illustrates a method of setting a most appropriate cache to provide contents in response to a request for contents in accordance with an embodiment.

FIG. 6 is a block diagram representation of a VPP node in accordance with an embodiment.

FIG. 7 is a block diagram representation of a physical router in accordance with an embodiment.

### DESCRIPTION OF EXAMPLE EMBODIMENTS

### General Overview

In one embodiment, a method includes obtaining a first request for first content through a physical network layer at a first node located in a content network layer, the first node being one of a plurality of nodes in the content network layer, each node of the plurality of nodes including the first content, wherein the request includes a first packet. The method also includes identifying a second node of the plurality of nodes from which to obtain the first content in response to the first request; and inserting a segment routing (SR) list into the first packet, wherein the SR list includes an address of the second node, the address of the second node being specified as a next destination of the first packet. Finally, the method includes providing the first packet including the SR list from the first node to the second node, wherein the second node is arranged to change the next destination of the first packet to an address of the first content included on the second node.

### Description

In classical content delivery network (CDN), caches from which to obtain content are selected though request routing engineering processes which often have a great deal of complexity. Such processes typically occur at layer 7 of an Open System Interconnect (OSI) model and above. Contents of caches are generally identified by Internet Protocol (IP) addresses, e.g., IPv6 and/or IPv6 addresses.

The same contents may generally be hosted in different caches. As such, a central control plane generally handles incoming requests for contents, and routes the requests to an appropriate cache. CDNs generally rely on hypertext transfer protocol (HTTP) request routing engineering processes, such as a HTTP 302 redirect, to identify a server or appropriate cache to deliver contents to a device.

By substantially eliminating the need for a central control plane that routes incoming requests from a device to an appropriate cache, and allowing caches to advertise what their contents such that a request is naturally routed to the most appropriate cache, the efficiency with which contents of a cache may be obtained may be increased. In one embodiment, requests for content may be routed to a most appropriate cache, or an elected server, without the need to utilize a HTTP request routing engineering process.

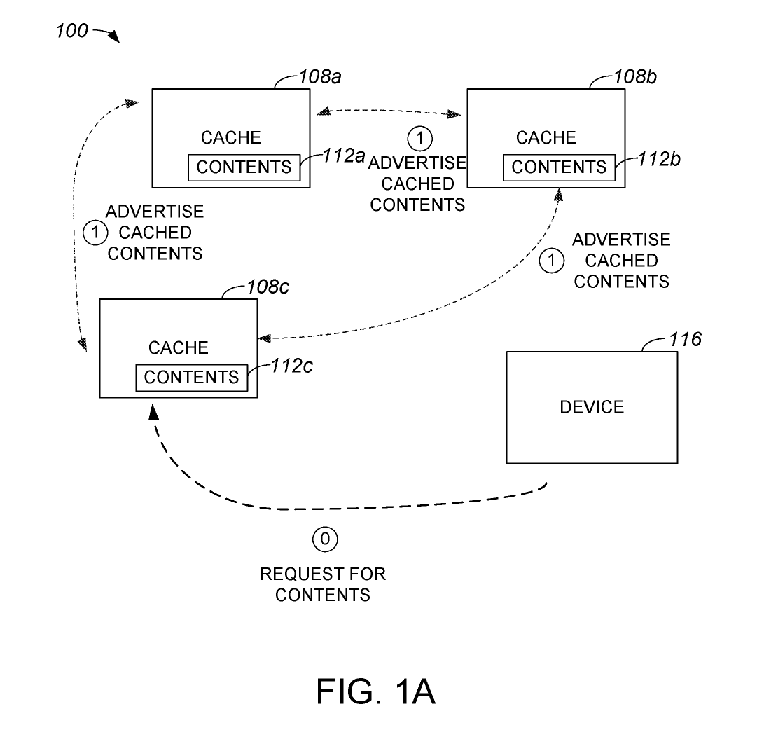

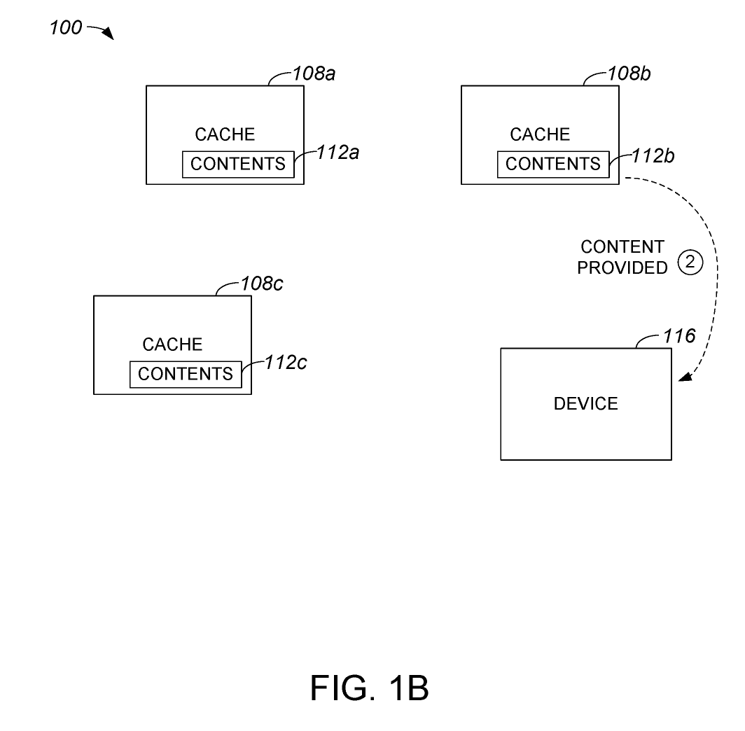

Referring initially to FIGS. 1A and 1B, an overall process of routing a request for content from a device to an appropriate cache will be described in accordance with an embodiment. FIG. 1A is a diagrammatic representation of a network in which caches advertise their contents in accordance with an embodiment. A network 100 generally includes caches 108a-c which each include contents 112a-c, respectively. Caches 108a-c includes substantially the same contents 112a-c, respectively. When a device 116 requests contents 112a-c, caches 108a-c advertise their respective contents 112a-c to each other. As will be appreciated by those skilled in the art, caches 108a-c may continually advertise contents 112a-c, and content 112a-c may expire in a particular cache 108a-c and, as such, cache 108a-c may cease advertising. In the embodiment as shown, a request for contents may be obtained initially by a cache 108c, e.g., received by cache 108c. As a result of advertising their respective contents 112a-c to each other, caches 108a-c may determine which cache 108a-c is the most appropriate for providing content to device 116 in response to a request for content.

In one embodiment, cache 108b is identified as the most appropriate cache from which to obtain contents, i.e., contents 112b. The identification of cache 108b as the most appropriate cache from which to obtain contents may generally involve machine learning and/or deep learning techniques. FIG. 1B is a diagrammatic representation network 100 in which contents 112b are provided to device 116 by most appropriate cache 108b in accordance with an embodiment.

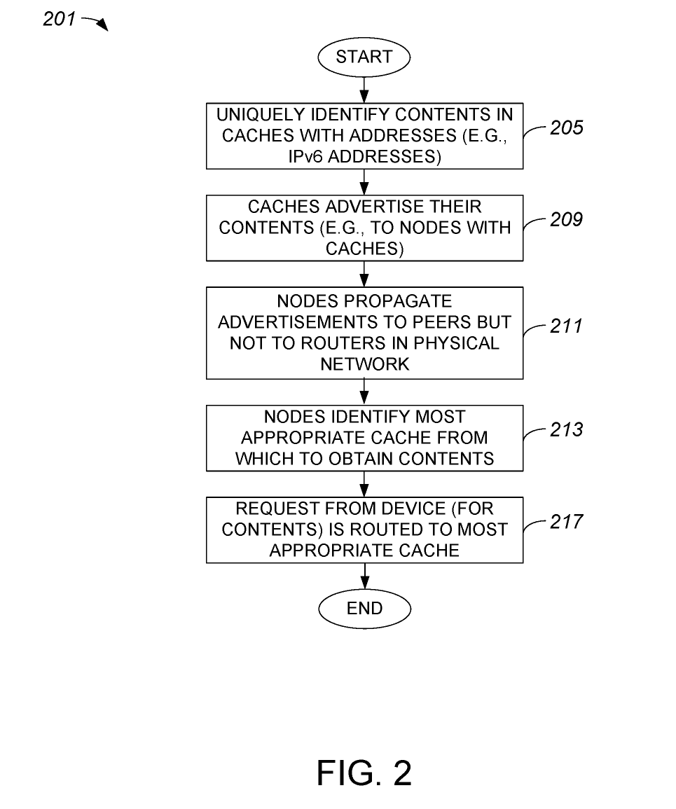

With reference to FIG. 2, a method of obtaining contents from an appropriate cache in accordance with an embodiment. A method 201 of obtaining contents from an appropriate cache begins at step 205 in which contents of caches are uniquely identified with addresses, e.g., IPv6 addresses. It should be appreciated that an IPv6 address may be used to access the cached content, and may be used substantially as the only member of a HTTP universal record locator (URL) used by a device to access the cached content.

In step 209, the caches each advertise their contents within a network to nodes which have caches. For example, a virtual machine (VM) of node that includes a cache may advertise its local node routes to addresses representing contents present in the cache. Each cache may advertise routes to the address that uniquely identifies its contents. As such, the address may be advertised several times to different nodes, e.g., VPP nodes. Each address may be advertised by a cache with an associated weight which may represent a cost to obtain the content from the cache. The cost may include, but is not limited to including, a cost associated with a current server load and/or a network cost to deliver content from a cache. As will be appreciated by those skilled in the art, a network cost may combine a substantially static cost related to a location in a service provider network of a cache with a dynamic cost relating to the amount of available bandwidth for streaming on a server.

After the caches each advertise their contents to nodes, the nodes propagate advertisements in step 211 to peers, e.g., other nodes with caches, but not to routers in a physical network, e.g., a service provider physical network. In one embodiment, nodes propagate advertisements to peers such that a content routing logical layer is effectively created above the physical network.

In step 213, nodes identify a most appropriate cache from which to obtain contents. For example, a first node may identify a most appropriate cache from which to obtain contents in the event that the first node obtains a request for the contents. Identifying a most appropriate cache may include, but is not limited to including, using a Generative Adversarial Network (GAN) or other unsupervised learning approaches that are agnostic to the domain of an application. In particular, the ability of GAN to learn disentangled representations is a measure of how well a device identifies a most appropriate cache from which to obtain content. Being able to interpret the learned representations is often a measure of extracting consistent proper meaning. Having the ability to reliably reconstruct content may enable successful transfer learning, and improve generality. Once the device identifies the most appropriate cache from which to obtain content, a request from the device for the contents is routed to the most appropriate cache in step 217, and the method of obtaining contents from an appropriate cache is completed.

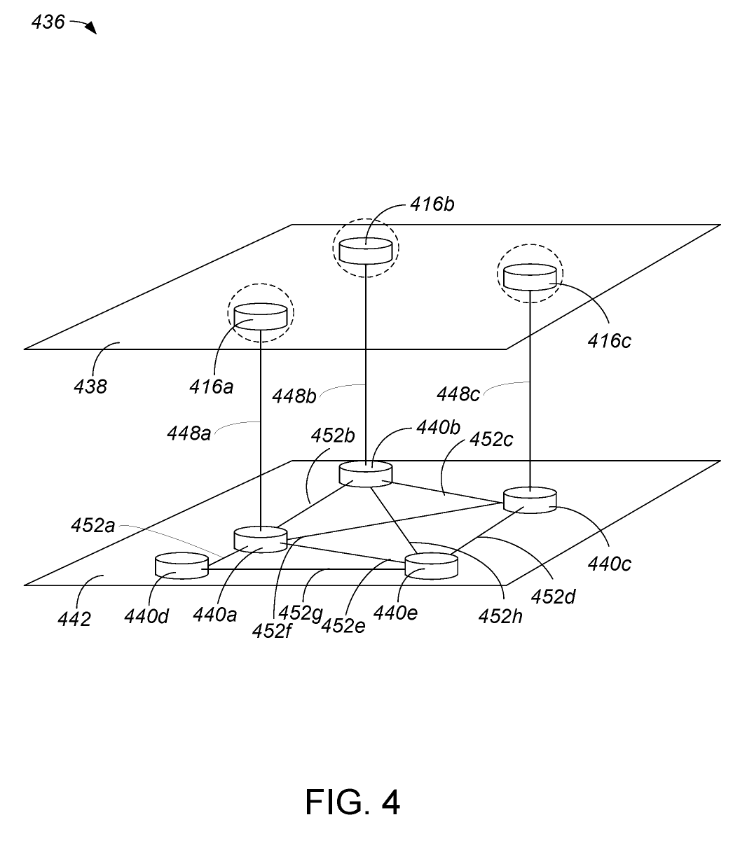

A cache or streamer machine typically runs a vector packet processing (VPP) node, although it should be appreciated that in lieu of a VPP node, a cache or streamer machine may run any suitable router. Although such a router associated with a cache may be a physical router, the router may instead be implemented in software. As will be appreciated by those skilled in the art, a VPP platform may be implemented to substantially create virtual switches and routers. A cache or streamer may be connected to an underlying physical network through a VPP node. Each VPP node has its own IP address on the physical network to enable VPP nodes to access their peers through the physical network. As such, VPP nodes may route traffic between each other through the physical network. That is, a plurality of VPP nodes effectively create a virtual network layer that sits on top of a physical network, as will be below with respect to FIG. 4.

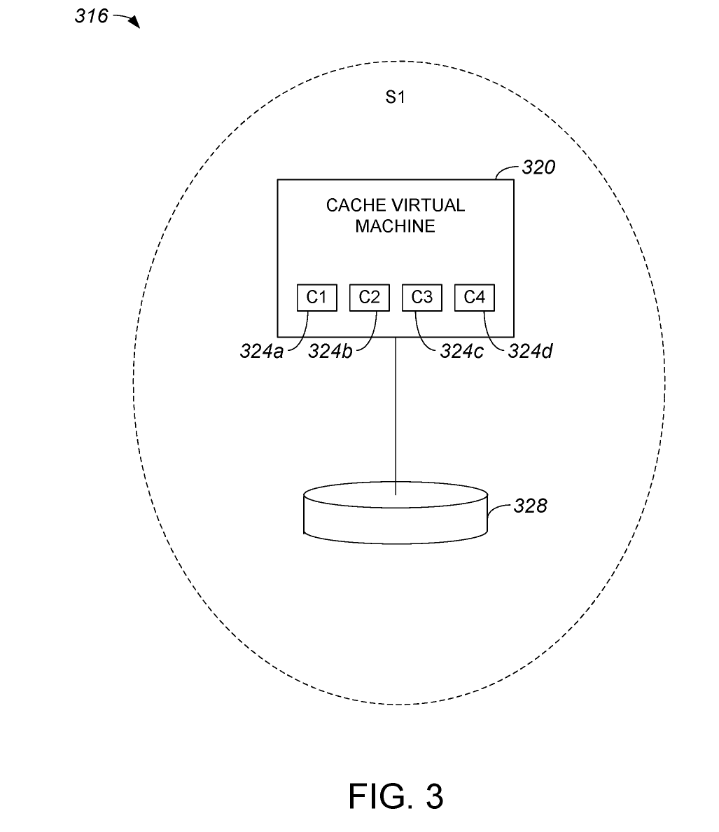

FIG. 3 is a diagrammatic representation of a VPP node in accordance with an embodiment. A VPP node 316 includes a cache VM 320 and a router 328. It should be appreciated that although cache VM 320 generally represents a cache, a cache is not limited to being a cache VM 320, and other implementations of a cache such s bar metal, a container, a kubernetes Pod may be possible. Cache virtual VM 320 typically includes contents 324a-d. VPP node 316 has an associated IPv6 address of “prefix::s1.” Contents cached in cache virtual machine 320 may have addresses such as “contentprefix::C1” for content C1 324a, “contentprefix::C2” for content C2 324b, “contentprefix::C3” for content C3 324c, and “contentprefix::C4” for content C4 324d. Node 316 or any component of node 316, e.g., cache VM 320, advertises its local node routes to the addresses for the contents cached in cache VM 320.

Substantially all VPP nodes or, more generally, cache or streaming machines, cooperate to define a virtual network layer or a “content” network that is logically independent from an underlying physical network. It should be appreciated, however, that each individual VPP node is effectively connected to the underlying physical network. FIG. 4 is a diagrammatic representation of an overall network with a physical plane and a “content” plane in accordance with an embodiment. An overall network 436 includes a content network/plane or virtual network layer 438 and a physical network/plane or routing layer 442. As shown, content network/plane 438 sits “on top of” physical network/plane 442. It should be appreciated, however, that while content network/plane 438 may not work or exist without physical network/plane 442, there is generally no hierarchy associated with the relationship between content network/plane 438 and physical network/plane 442.

Cache or streamer machines 416a-c, e.g., machines which include VPP nodes, are located in content network/plane 438. Each cache or streamer machine 416a-c in content network/plane 438 is effectively connected to physical network/plane 442, and includes a local cache VM that is configured to deliver contents. Routers 440a-e, which are arranged in physical network/plane 442, are arranged such that content requests from devices pass through at least one router 440a-e in physical network/plane 442 to an appropriate cache or streamer machine 416a-c. As shown, routers 440a-e are in communication with each other over multiple links 452a-h. Router 440a is in communication with cache or streamer machine 416a over link 448a, router 440b is in communication with cache or streamer machine 416b over link 448b, and router 440c is in communication with cache or streamer machine 416c over link 448c.

When a device (not shown) makes a request for content that is accessible from cache or streamer machines 416a-c, a most appropriate VPP node associated with a cache or streamer machine 416a-c may be identified. A request issued by a device (not shown) generally first reaches a router 440a-e, e.g., router 440d, which, based on a destination address representing content, routes the request to a router 440a-3 from content network/plane 438. If an assumption is made that substantially all contents are associated with the same prefix, e.g., contentprefix::/64, then substantially as soon as a router 440a-e has a route towards the prefix, a request may be routed. For example, router 440d may have a route toward contentprefix ::/64 through router 440a, which itself may have a route toward contentprefix::/64 through its port 448a. It should be appreciated that there may be several content prefixes corresponding to several content owners.

In one embodiment, the addresses, e.g., the IPv6 addresses, of contents in VPP nodes on cache or streamer machines 416a-c all have substantially the same prefix, and the prefixes may be advertised by each VVP node of cache or streamer machine 416a-c to the physical router 440a-h it is connected to. That is, a VPP node of cache or streamer machine 416a may advertise contentprefix:: to router 440a, a VPP node of cache or streamer machine 416b may advertise contentprefix:: to router 440b, and a VPP node of cache or streamer machine 416c may advertise contentprefix:: to router 440c. As such, substantially any request for content provided by a device (not shown) may be routed to a VPP Node of cache or streamer machine 416a-c in content network/plane 438. Any suitable method may generally be used by physical network/plane 442 to select or to otherwise choose a particular VPP node of cache or streamer machine 416a-c from which to obtain content. For example, such a selection may be based on a shortest path routing technique. It should be appreciated, however, that because physical network routing tables are typically relatively stable, a request from a particular device will substantially always be received or otherwise obtained by the same VPP node of cache or streamer machine 416a-c. That is, for a given device (not shown) and for a given contentprefix::, a request may substantially always follow the same path to reach one cache from content network/plane 438. The first cache that is reached, however, is not necessarily the cache that delivers the content.

Each VPP node of cache or streamer machine 416a-c that forms content network/plane 438 is aware of substantially all routes to content that are present, e.g., present in at least once VPP node of cache or streamer machine 416a-c. When a request of content coming from a device (not shown) arrives at a first VPP node of cache and streamer machine 416a-c, as for example a first VPP node of a first cache and streamer machine 416a, first VPP node of first cache and streamer machine 416a may determine a most appropriate VPP node of first cache and streamer machines 416a-c to handle the request. It should be appreciated that identifying a most appropriate VPP node generally involves identifying a most appropriate cache and streamer machine 416a-c.

When a most appropriate cache or streamer machine 416a-c is identified, or when a VPP node address associated with cache or streamer machine 416a-c is identified as the most appropriate location from which to obtain contents, a server to which to provide the contents may effectively be selected. However, routing an initial device SYN packet from a device (not shown) to the same server, i.e., a selected VPP node, is generally not sufficient to ensure that substantially all subsequent IP packets will be routed to the same server, as substantially all other VPP nodes are accessible through the same VPP interface that is used to connect to the same server to physical network/plane 442. In addition, because physical network/plane 442 generally does not have routes towards contents of cache and streamer machines 416a-c and instead has routes toward cache and streamer machines 416a-c themselves, a VPP node which received an initial SYN packet from a device (not shown) as part of a device content request may insert a segment routing (SR) list into the SYN packet. The SR list may contain an IPv6 address of a selected server or, more specifically, a corresponding VPP node, that contents will typically be delivered from. The address of the selected server may then be used to identify a next destination for the SYN packet. The SYN packet may then be routed through physical network/plane 442 to a next destination, which is the selected server. Upon obtaining the SYN packet, the selected server may then change the destination address of the SYN packet to the address of the content, and then route the packet to a local virtual machine which accepts a connection.

Because requests for contents issued by a device (not shown) may be received by a VPP node of cache and streamer machine 416a-c from content network/plane 438, the requests for contents may be monitored by observing network traffic passing through VPP nodes. For example, system activity may effectively be tracked by monitoring route advertisement messages, as well as content delivery information extracted from netflow information provided by, but not limited to being provided by, content routers hosted by caches.

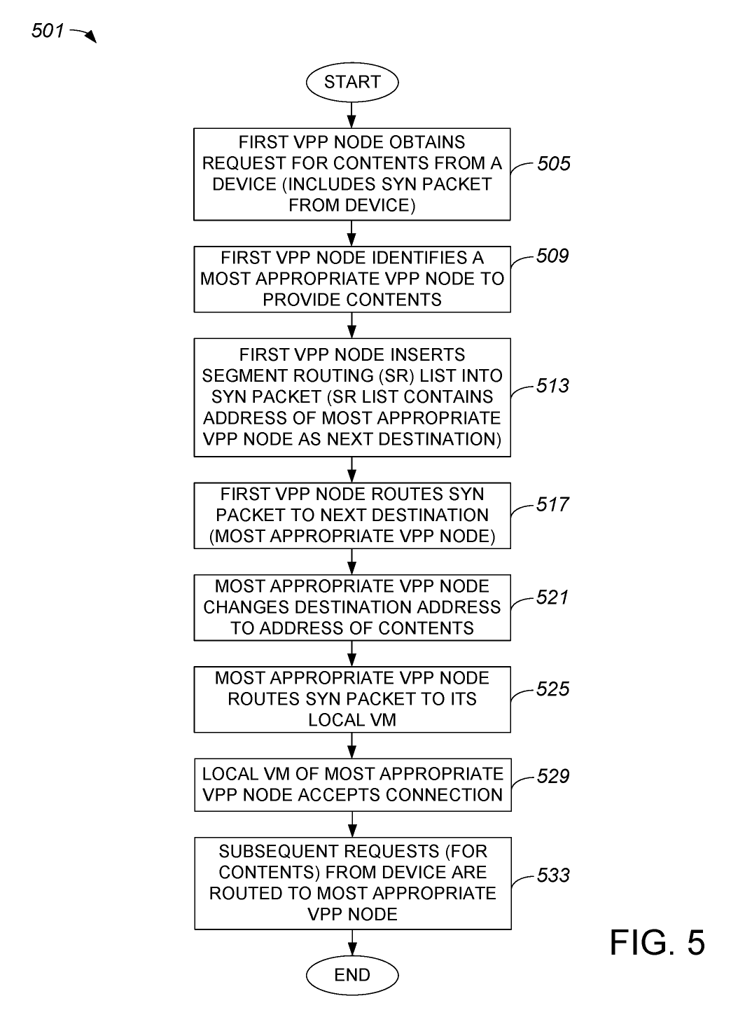

FIG. 5 is a process flow diagram which illustrates a method of setting a most appropriate cache to provide contents in response to a request for contents in accordance with an embodiment. A method 501 of setting a most appropriate cache to provide contents in response to a request for contents begins at step 505 in which a first VPP node obtains a request for content from a device. In general, the request includes a SYN packet. That is, the first VPP node receives a request for contents that includes an initial SYN packet.

In step 509, the first VPP node identifies a most appropriate VPP node to provide contents in response to the request for contents. As previously mentioned, any suitable method may generally be used to identify the most appropriate VPP node to provide content. In addition, characteristics used to identify the most appropriate VPP node to provide content may vary depending upon factors including, but not limited to including, network conditions and requirements.

After the first VPP node initiates identifying the most appropriate VPP node to provide contents, or elects a server, the first VPP node inserts an SR list into the SYN packet in step 513. That is, the VPP node effectively adds an SR header to the SYN packet. The SR list contains an address associated with the most appropriate VPP node to provide contents. In one embodiment, the address associated with the most appropriate VPP node is an IPv6 address, although it should be appreciated that the address may generally be any address associated with the most appropriate VPP node. The address associated with the most appropriate VPP node is set in the SR list as a next destination for the SYN packet.

From step 513, process flow moves to step 517 in which a first VPP node routes the SYN packet to the next destination, i.e., the most appropriate VPP node. In one embodiment, when the first VPP node is the most appropriate VPP node, the first VPP node adds its own address in an SR list, e.g., for consistency and to effectively ensure that subsequent packets will hit or otherwise reach the first VPP node. Upon obtaining the SYN packet from the first VPP node, the most appropriate VPP node changes the destination address in the SYN packet to the address of the requested contents in step 521. Once the destination address is updated, the most appropriate VPP node routes the SYN packet to its local VM in step 525.

The local VM of the most appropriate VPP node accepts a connection, or effectively otherwise accepts a request for content, in step 529. After the local VM of the most appropriate VPP node accepts a connection, then subsequent requests for contents, made by the device, are routed in step 533 to the most appropriate VPP node, i.e., the elected server. The method of setting a most appropriate cache to provide contents in response to a request for contents is completed upon subsequent requests from a device being routed to the most appropriate VPP node.

A SR list, or SR header, inserted by the first VPP node into a SYN packet is effectively maintained for the duration of a content delivery session between a device and a most appropriate VPP node identified by the first VPP node. Thus, packets sent by the device are substantially directly routed to the most appropriate VPP node, or to the elected server. That is, packets sent by the device may be directed routed by a physical network to the most appropriate VPP node.

In one embodiment, the device that requests contents is SR capable. In the event that the device is not SR capable, the SR list or header inserted into a SYN packet by a first VPP node may contain both an address of a most appropriate VPP node and an address of the first VPP node. When the SR list contains both the address of the most appropriate VPP node and the address of the first VPP node, a SYNACK packet coming from a VM associated with the most appropriate VPP node passes through the most appropriate VPP node, then through the first VPP node which removes an SR header and then provides the SYNACK packet to the device. As such, each VPP node associated with a content network/plane effectively functions as a SR gateway for substantially all requests coming from devices. Thus, each VPP node may be a stateful node.

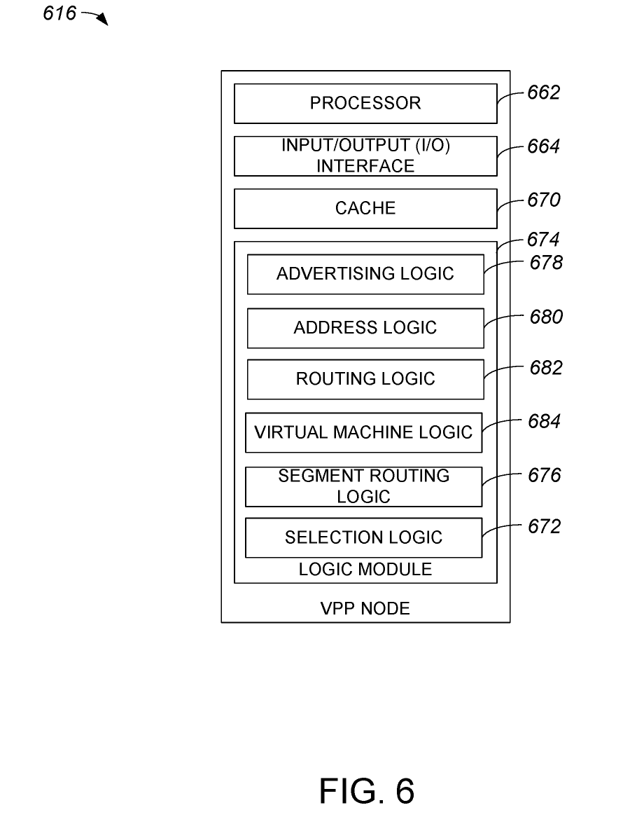

FIG. 6 is a block diagram representation of a VPP node, which may be part of a cache or streamer machine, in accordance with an embodiment. A VPP node 616 may be included as part of an overall cache or streamer machine. As shown, VPP node 616 includes a processor 662, an input-output (I/O) interface 664, a cache 670, and a logic module 674. Processor 662 generally includes at least one microprocessor, and I/O interface 664 is configured to allow VPP node 616 to communicate within an overall network. That is, I/O interface 664 allows VPP node 616 to communicate with peers or other VPP nodes in a content network/plane, as well as with an underlying physical network/plane. I/O interface 664 is generally arranged to support both wired and wireless communications. Logic module 674 generally includes hardware and/or software logic arranged to be executed by processor 662.

Logic module 674 includes advertising logic 678, address logic 680, routing logic 782, VM logic 684, SR logic 676, and selection logic 672. Advertising logic 678 allows VPP node 616 to advertise routes to contents stored in cache 670 to other VPP nodes in a content network/plane. Address logic 680 allows addresses to contents in cache 670 to be determined, and may maintain content routing tables. Routing logic 682 is configured, in one embodiment, to obtain advertisements from other VPP nodes in a content network/plane, and to propagate the obtained advertisements to other VPP nodes, but not to routers associated with a physical network/plane. Routing logic 682 may use a protocol such as Border Gateway Protocol (BGP) to propagate obtained advertisements to peers, although it should be appreciated that other protocols may instead be used. Routing logic 682 may also generally be VM logic 684 is configured to support a cache VM. SR logic 676 allows VPP node 616 to support SR, and enables VPP node 616 to add SR lists to SYN packet. Selection logic 672 is arranged to allow a most appropriate cache associated with a content/network plane to be selected to provide contents in response to requests for content obtained by VPP node 616. In one embodiment, selection logic 672 may apply machine learning and/or deep learning techniques to ascertain a most appropriate cache from which to obtain contents.

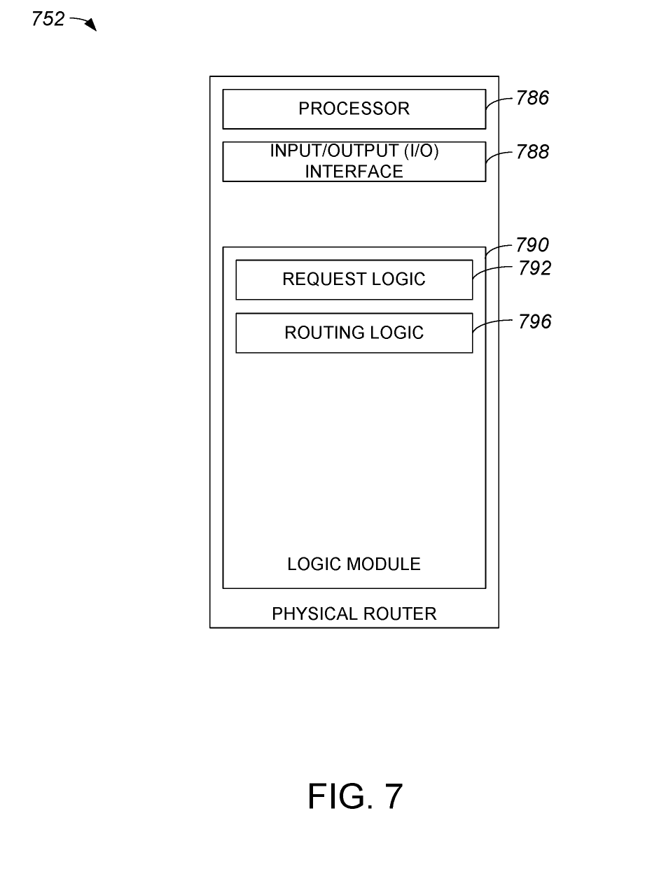

FIG. 7 is a block diagram representation of a physical router in accordance with an embodiment. A physical router 752, which is located in a physical network/plane or layer, includes a processor 786, an I/O interface 788 arranged to allow physical router 752 to communicate within an overall network, and a logic module 790 which includes hardware and/or software logic arranged to be executed by processor 786. Logic module 790 includes request logic 792 and routing logic 796. Request logic 792 is configured to send or otherwise provide requests for contents to cache or streamer machines. Once contents are obtained in response to requests, routing logic 796 routes the contents appropriately.

In some instances, requested contents may not be present in any cache. When requested contents are not present in any cache, an initial request for the contents may be routed to one VPP node or server, as for example based on a default route. Because the requested contents are not present in any cache, the initial request for contents generally results in a cache miss in the VM which receives the request, as substantially all VMs accept connections for a whole content prefix. It should be appreciated that a cache miss may be handled using any suitable method, including a backfill operation.

An empty cache may effectively become a part of a content delivery system. In becoming a part of a content delivery system, an empty cache may initially advertise a content prefix or smaller prefixes that represent content groups. The prefixes may be selected using specific policies or any suitable mechanism. An initial request for content may cause a cache miss and, in one embodiment, effectively cause a backfill operation to commence with respect to the cache. In other words, an initial request for content may initiate a caching operation. As a consequence of a caching operation, a corresponding content address may be advertised by a VM to it local VPP node.

Although only a few embodiments have been described in this disclosure, it should be understood that the disclosure may be embodied in many other specific forms without departing from the spirit or the scope of the present disclosure. By way of example, as content request issued by a device may be received by VPP nodes from a content network, the requests may be monitored by observing network traffic passing through the VPP nodes. As content advertisement information may be propagated across substantially all VPP nodes in a content network/plane, each of the VPP nodes may have a map of contents and caches. By capturing information relating to the maps of contents and caches of a particular VPP node, real-time information about the life cycles of the contents may be determined. In one embodiment, the real-time information may be used to train a machine learning and/or deep learning system. Training a machine learning and/or deep learning system may serve to substantially optimize cache parameters, and/or to substantially minimize an overall cost of delivery.

Advertising addresses or prefixes corresponding to contents which are not present in a cache may be used by caching running under a relatively low load. In one embodiment, advertising such addresses or prefixes may allow a cache to attract additional traffic.

As mentioned above, VPP nodes may be stateful such that devices which are not SR capable may obtain contents from the VPP nodes in accordance with the present disclosure. In lieu of VPP nodes being stateful, however, devices which are not SR capable may be supported by the advertisement of SR lists together with addresses associated with contents that are available. In general, a router in a physical network is a SR capable device. While the physical network itself does not need to be SR capable, it should be appreciated that in some embodiments, the physical network may be SR capable.

When content that was present in a cache is removed from the cache, a corresponding route to the content is removed from cache or streaming machine, e.g., VPP node, associated with the cache. For example, a local VPP node may remove a route to the content that is no longer in its cache.

It should be appreciated that the speed at which content routing tables will converge in a content routing logical layer generally does not affect the physical network of a service provider. This convergence time is generally less than the amount of time associated with physical caches reevaluating each cache entry to determine which contents to keep and which contents to purge or to otherwise remove.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. By way of example, in addition to potentially including a deadline estimate in a packet to facilitate downstream processing, an index of confidence in the deadline estimate may be calculated and either utilized locally or included in the packet. Therefore, the present examples are to be considered as illustrative and not restrictive, and the examples is not to be limited to the details given herein, but may be modified within the scope of the appended claims.

What is claimed is:

1. A method comprising:
obtaining a first request for first content through a physical network layer at a first node located in a content network layer, the first node being one of a plurality of nodes in the content network layer, each node of the plurality of nodes including the first content, wherein the first request includes a first packet;
identifying a second node of the plurality of nodes from which to obtain the first content in response to the first request;
inserting a segment routing (SR) list into the first packet, wherein the SR list includes an address of the second node, the address of the second node being specified as a next destination of the first packet; and
providing the first packet including the SR list from the first node to the second node, wherein the second node is arranged to change the next destination of the first packet to an address of the first content included on the second node.

2. The method of claim 1 wherein identifying the second node of the plurality of nodes from which to obtain the first content in response to the first request includes applying at least one of a machine learning technique and a deep learning technique.

3. The method of claim 1 wherein identifying the second node of the plurality of nodes from which to obtain the first content in response to the first request includes minimizing a cost associated with delivering the first content in response to the first request.

4. The method of claim 1 wherein the first packet is a SYN packet and the address of the second node is an IPv6 address.

5. The method of claim 1 wherein the first node is a vector packet processing (VPP) node, the VPP node being arranged to run on a cache or streamer machine.

6. The method of claim 1 wherein the second node is further arranged to route the first packet to a virtual machine associated with the second node, wherein the first content is stored in a cache associated with the second node.

7. Logic encoded in one or more tangible non-transitory, computer-readable media for execution and when executed operable to:
obtain a first request for first content through a physical network layer at a first node located in a content network layer, the first node being one of a plurality of nodes in the content network layer, each node of the plurality of nodes including the first content, wherein the first request includes a first packet;
identify a second node of the plurality of nodes from which to obtain the first content in response to the first request;
insert a segment routing (SR) list into the first packet, wherein the SR list includes an address of the second node, the address of the second node being specified as a next destination of the first packet; and
provide the first packet including the SR list from the first node to the second node, wherein the second node is arranged to change the next destination of the first packet to an address of the first content included on the second node.

8. The logic of claim 7 wherein the logic operable to identify the second node of the plurality of nodes from which to obtain the first content in response to the first request includes logic operable to apply at least one of a machine learning technique and a deep learning technique.

9. The logic of claim 7 wherein the logic operable to identify the second node of the plurality of nodes from which to obtain the first content in response to the first request includes logic operable to minimize a cost associated with delivering the first content in response to the first request.

10. The logic of claim 7 wherein the first packet is a SYN packet and the address of the second node is an IPv6 address.

11. The logic of claim 7 wherein the first node is a vector packet processing (VPP) node, the VPP node being arranged to run on a cache or streamer machine.

12. The logic of claim 7 wherein the second node is further arranged to route the first packet to a virtual machine associated with the second node, wherein the first content is stored in a cache associated with the second node.

13. An apparatus comprising:
a processor;
an input/output (I/o) interface; and
a logic module, the logic module including logic arranged to be executed by the processor, the logic module including
a first arrangement configured to obtain a first request for first content from a physical network layer on the I/O interface the first request including a first packet,
a second arrangement configured to identify a first node from which to obtain the first content, the first node being one of a plurality of nodes including the first content, the plurality of nodes being included in a content network layer, a third arrangement configured to insert a segment routing (SR) list into
the first packet, wherein the SR list includes an address of the first node, the address of the first node being specified as a next destination of the first packet and
a fourth arrangement configured to provide the first packet including the SR list to the first node, wherein the first node is arranged to change the next destination of the first packet to an address of the first content included in a cache of the first node.

14. The apparatus of claim 13 wherein the apparatus is included in the content network layer.

15. The apparatus of claim 13 wherein the second arrangement is configured to apply at least one of a machine learning technique and a deep learning technique to identify the first node from which to obtain the first content.

16. The apparatus of claim 13 wherein the second arrangement is configured to minimize a cost associated with delivering the first content in response to the first request.

17. The apparatus of claim 13 wherein the first packet is a SYN packet and the address of the first node is an IPv6 address.

18. The apparatus of claim 13 wherein the apparatus is a vector packet processing (VPP) node, the VPP node being arranged to run on a cache or streamer machine.

19. The apparatus of claim 13 further including:
a cache, the cache including the first content, wherein the logic module includes a fifth arrangement, the fifth arrangement configured to advertise at least one route to the first content included in the cache to the plurality of nodes.

20. The apparatus of claim 13 wherein the first arrangement is configured to advertise the at least one route using a border gateway protocol (BGP).
